(19) United States
(12) Patent Application Publication
(10) Pub. No.: US 2007/0241243 A1
(43) Pub. Date: Oct. 18, 2007

(54) Tripod with a Column Divisible into Two Portions

(76) Inventor: Paolo Speggiorin, Mussolente (VI) (IT)

Correspondence Address: RATNERPRESTIA, P O BOX 980, VALLEY FORGE, PA, 19482-0980, US

(21) Appl. No.: 11/579,432

(22) PCT Filed: Mar. 8, 2005
(86) PCT No.: PCT/EP05/02417

§ 371 Date: Nov. 3, 2006

(30) Foreign Application Priority Data
May 13, 2004 (IT) PD 2004 A 000121

(51) Int. Cl. F16M 11/38

(52) U.S. Cl. 248/170

(57) ABSTRACT

A tripod includes a cross-piece in which a column which can be adjusted in an axial direction is inserted, and the column includes a rod having, at one end, a support for optical-photographic equipment. The rod includes at least a first and a second portion, at the facing ends of which are provided an element and a counter-element for male-female coupling in order to connect the first and second portions axially, the one as the extension of the other, wherein the first portion and respective coupling element are made in one piece with the support.

This application is a U.S. National Phase Application of PCT International Application PCT/EP2005/002417 and incorporated by reference herein.

### TECHNICAL FIELD

The present invention relates to a tripod having a column which can be divided into two portions.

### BACKGROUND OF THE INVENTION

Tripods for photographic use comprise a cross-piece to which three telescopic legs and a support for securing a photographic apparatus are connected in known manner. The mechanism for connecting the legs to the cross-piece enables the legs to be locked at various opening angles.

The present invention relates in particular to a type of tripod in which the support for securing the photographic apparatus is connected to a column which can slide axially in an opening in the cross-piece in order to permit easy height adjustment of the apparatus.

However, in spite of the greater ease of use provided by the height adjustment, that type of tripod does have some problems. Although, on the one hand, it will be appreciated that the column has a relatively large axial extension because the range of height adjustment of the apparatus depends thereon, on the other hand the column part projecting below the support of the photographic apparatus prevents that apparatus from being positioned at a very low point, for example, in order to take photographs at levels near the ground.

Various mechanisms that enable the height of the column to be changed and the column to be locked in the desired position are known. An example thereof, constructed to take into account the problem indicated, is described in European Patent Application No. 751338 in the name of Velbon in which the slidable column comprises an upper part connected to the support for securing the apparatus and a lower part which can be removed in the case in which photographs have to be taken from a low angle.

The upper part of the column comprises a first metal rod portion, on one end of which the support for securing the apparatus is constrained and on the longitudinally opposite end of which is arranged a coupling element capable of being connected to a counter-coupling element provided on the second metal rod portion.

However, the mechanism for coupling the two column portions of the Velbon solution exhibits some problems due mostly to the structural complexity.

A first problem to be solved is that of the clearance between the coupled portions which, according to the prior art, must be eliminated during the production stages by accurate assembly. However, any knocks or falls to which the column is subjected may loosen the fastening of some parts of the coupling mechanism. For example, when the two portions are separated, some relatively sharp elements of the locking mechanism are left exposed in the lower part of the column and can be easily damaged.

### BRIEF DESCRIPTION OF THE INVENTION

The problem on which the present invention is based is to produce a tripod comprising a column which can be divided into two pieces and which is designed structurally and functionally to overcome the limitations set out above with reference to the above-mentioned prior art.

The problem is solved by the present invention by means of a tripod comprising a column which can be divided into two pieces, and the column includes a rod having, at one end, a support for optical or photographic equipment. The rod includes at least a first portion and a second portion, respective means and counter-means for male-female coupling being provided at the facing ends of the first and second portions in order to connect them axially, the one as the extension of the other, and the first portion and respective coupling means are made in one piece with the support.

### BRIEF DESCRIPTION OF THE DRAWINGS

The features and advantages of the invention will emerge more clearly from the detailed description of a preferred embodiment thereof which is illustrated by way of non-limiting example with reference to the appended drawings in which:

FIG. 1 is a perspective diagrammatic view of a tripod with a photographic apparatus;

FIG. 2 is a perspective view of a first column portion of the tripod of FIG. 1;

FIG. 3 is a perspective view of a second column portion of the tripod of FIG. 1;

FIG. 4 is a longitudinal section through the column of the tripod of FIG. 1; and

FIG. 5 is a view of a detail of the second column portion of the tripod of FIG. 1.

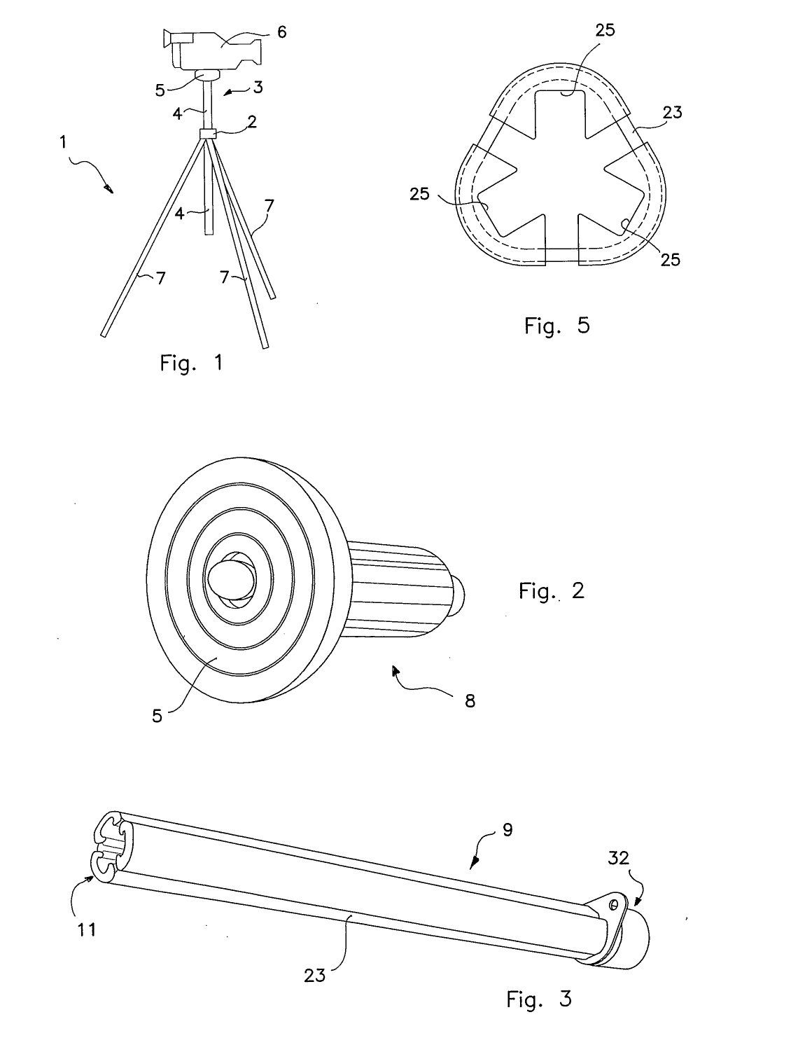

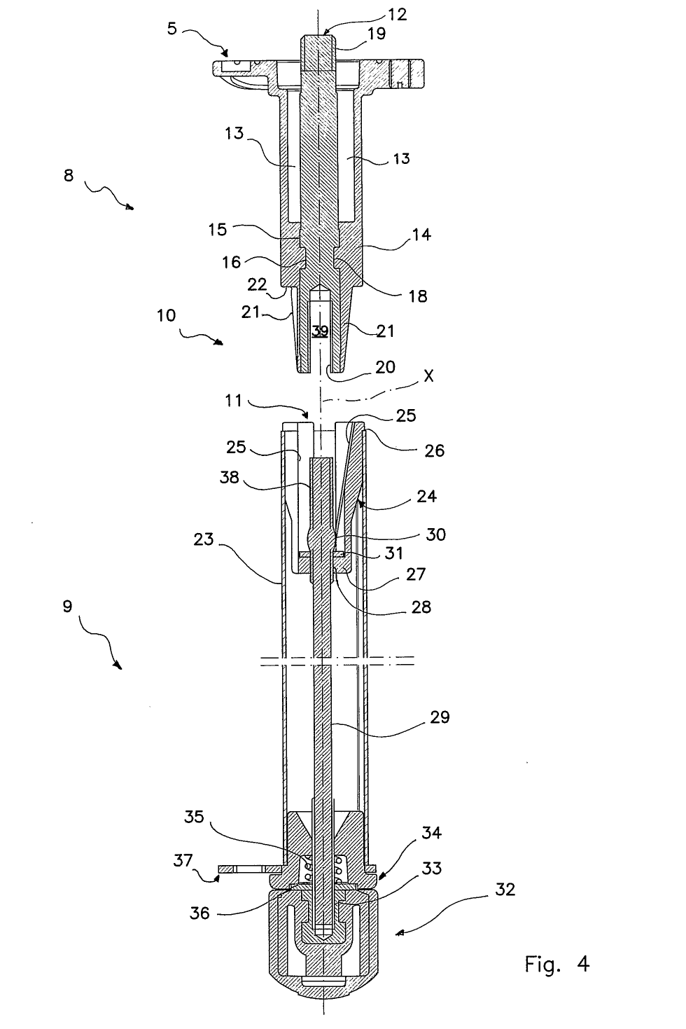

### PREFERRED EMBODIMENT OF THE INVENTION

In the Figures, a tripod having a cross-piece 2 in which a column 3 produced in accordance with the present invention is inserted and supported in such a manner that it can slide in an axial direction is indicated 1. Three or more legs 7 which can be adjusted in length telescopically converge in the cross-piece 2 in a known manner.

The column 3 extends longitudinally with an axis X and comprises an anchoring disc 5 for an optical or photographic apparatus 6 and a rod 4 which has a generally triangular cross-section with rounded vertices and which is divided into a first portion 8 and a second portion 9. The first and second portions are removably connected, the one as the axial extension of the other, by means of respective coupling elements, a male coupling element 10 which is fixedly joined to the portion 8 and a female coupling element 11 which is fixedly joined to the portion 9. The anchoring disc 5, the first rod portion 8 and the male coupling 10 are produced in one piece from plastic material, preferably from reinforced resin, forming a monolithic element. This element is traversed axially by a shaft 12.

A cylindrical cavity 13 which is coaxial with the shaft 12 is located axially in the anchoring disc 5 and in the first rod portion 8. At the bottom of the cavity 13 is a base 14 traversed axially by a passage 15 in which the shaft 12 is held axially and supported rotatably by means of an annular protuberance 16 of the base 14, which protuberance projects into the passage 15 and engages in an annular groove 18 of the shaft.

The shaft 12 has opposite threaded ends having, respectively, an external thread 19 projecting from the disc 5 and, at the opposite end, an internal thread 20 in a blind axial hole 39.

The male coupling element 10 is located on the first portion 8 at the opposite end to the disc 5 and comprises three wedge-like elements 21 (preferably in a number equal to the number of sides of the cross-section of the first portion, although at least one thereof is sufficient) which are arranged at an equal angular distance from one another and which extend from a shoulder 22 and taper away therefrom and from the disc 5.

The second rod portion 9 includes a tubular element 23, preferably of metal, which also has an equilateral triangular cross-section with rounded vertices and which carries the female coupling element 11. The female coupling element 11 comprises a beaker formation 24 which is produced from plastic material and which is inserted into the portion 9 at an axial end thereof. The beaker formation 24 in turn comprises three (or more) axial slots 25 which are arranged at an equal angular distance from one another and which have a wedge-like impression corresponding to the shape of the wedge-like elements 21. The beaker formation 24 has a lip 26 by means of which it grips the free rim of the tubular element 23 and, at the opposite end, it is closed by a base 27 traversed axially by a passage 28. A second shaft 29 extends axially inside the second portion 9, through the passage 28, and is supported at an intermediate part thereof, being held axially but being able to rotate about its own axis, by means of a radial bulge thereof 30 which, with the interposition of a washer 31, abuts the base 27 which closes the bottom of the beaker formation 24.

The second shaft 29 has, at the opposite end to the beaker formation 24, a hand-grip 32 to which it is secured by means of a threaded coupling 33. It also extends through a plug 34 inserted in the corresponding end of the tubular element 23. A spring 35 with a washer 36 with shim adjustment to a given clearance is interposed between the plug 34 and the hand-grip 32. Finally, a fastening element 37 is provided for fastening the second portion 9, when it is removed from the first, in order to prevent it from being lost.

There is also a thread 38 at that end of the shaft 29 which is accommodated in the beaker formation, which thread 38, by engaging in the threaded hole 39 of the first shaft, enables the two portions 8, 9 to be joined securely to each other.

The connection between the two rod portions 8, 9 is rendered firm and free from clearance owing to the engagement of the wedge-like elements 21 of the male coupling 10 in the slots 25 of the female coupling 11. By screwing the shaft 29 into the shaft 12, the wedge-like elements 21 generate compressions that are equally distributed over the entire perimeter of the female coupling 11, automatically recovering and compensating for any asymmetry or imperfection in the couplings. Thanks to a suitable choice of the plastic materials used for the couplings, it is also possible to confer on the surfaces involved in the engagement, anti-seizure properties which permit a rapid and easy disengagement operation.

The present invention permits the production of a tripod for photographic use having a divisible column in which the entire upper rod portion is produced in one piece from plastics material comprising, in addition to the coupling mechanism, also the rod and the disc for anchoring the photographic apparatus.

The column which can be divided into two and which is produced in accordance with the present invention permits rapid and simple assembly, and the structure of the male-female coupling makes it possible to obtain a joint which is firm, durable over time and free from clearance.

In addition, the connecting mechanism is characterised by substantial strength and, even when the rods are separated, mechanisms of the coupling which may be damaged by knocks or falls are not left exposed.

The present invention therefore solves the problems mentioned above with regard to the mentioned prior art. In addition, it provides a solution for producing the entire upper part of the column at low cost: it is possible to produce the finished piece by the injection-moulding of plastics material, thus eliminating all of the mechanical parts which traditionally make up the upper part of the column and all of the traditionally necessary mechanical assembly operations.

1. A tripod comprising a cross-piece in which a column which can be adjusted in an axial direction is inserted, the column comprising a rod having, at one end, a support for optical or photographic equipment, the rod including at least a first portion and a second portion, respective means and counter-means for male-female coupling being provided at the facing ends of the first and second portions in order to connect them axially, the one as the extension of the other, and the first portion and respective coupling means are made in one piece with the support.

2. The tripod according to claim 1, wherein the first portion is produced from plastics material.

3. The tripod according to claim 1, wherein the first portion is produced with a reinforced resin.

4. The tripod according to claim 1, wherein the male coupling is fixedly joined to the first portion.

5. The tripod according to claim 1, wherein the female coupling is formed in a beaker element inserted into the corresponding end of the second portion.

6. The tripod according to claim 1, wherein the female coupling is produced from plastics material.

7. The tripod according to claim 1, wherein at least the second portions is tubular.

8. The tripod according to claim 1, wherein each of the first and second portions comprises a respective shaft, the shafts adapted to removably join each other and the shafts being supported and held in the respective rod portions.

9. The tripod according to claim 8, wherein the shafts can be removably joined to each other by means of a threaded coupling.

10. The tripod according to claim 5, wherein the shaft of the second portion is held between the beaker element and a hand-grip at the axially opposite end of the second portion and is subjected to a resilient load between the hand-grip and a radial bulge in the shaft.

11. The tripod according to claim 2, wherein the male coupling is fixedly joined to the first portion.

12. The tripod according to claim 3, wherein the male coupling is fixedly joined to the first portion.

13. The tripod according to claim 2, wherein the female coupling is formed in a beaker element inserted into the corresponding end of the second portion.

14. The tripod according to claim 3, wherein the female coupling is formed in a beaker element inserted into the corresponding end of the second portion.

15. The tripod according to claim 4, wherein the female coupling is formed in a beaker element inserted into the corresponding end of the second portion.

16. The tripod according to claim 2, wherein each of the first and second portions comprises a respective shaft, the shafts adapted to removably join each other and the shafts being supported and held in the respective rod portions.

17. The tripod according to claim 3, wherein each of the first and second portions comprises a respective shaft, the shafts adapted to removably join each other and the shafts being supported and held in the respective rod portions.

18. The tripod according to claim 4, wherein each of the first and second portions comprises a respective shaft, the shafts adapted to removably join each other and the shafts being supported and held in the respective rod portions.

19. The tripod according to claim 5, wherein each of the first and second portions comprises a respective shaft, the shafts adapted to removably join each other and the shafts being supported and held in the respective rod portions.

20. The tripod according to claim 6, wherein each of the first and second portions comprises a respective shaft, the shafts adapted to removably join each other and the shafts being supported and held in the respective rod portions.

21. The tripod according to claim 7, wherein each of the first and second portions comprises a respective shaft, the shafts adapted to removably join each other and the shafts being supported and held in the respective rod portions.
